(19) United States
(12) Patent Application Publication
(10) Pub. No.: US 2026/0213595 A1
(43) Pub. Date: Jul. 23, 2026

(54) ROTOR SLEEVE, ROTOR, AND MOTOR

(71) Applicant: FANUC CORPORATION, Minamitsuru-gun, Yamanashi (JP)

(72) Inventors: Shouta TEZUKA, Yamanashi (JP); Kenji KAWAI, Yamanashi (JP)

(73) Assignee: FANUC CORPORATION, Minamitsuru-gun, Yamanashi (JP)

(21) Appl. No.: 19/143,139

(22) PCT Filed: Mar. 7, 2023
(86) PCT No.: PCT/JP2023/008444

§ 371 Date: Jun. 25, 2025

(51) Int. Cl. H02K 1/30

(52) U.S. Cl. CPC H02K 1/30

(57) ABSTRACT

A rotor sleeve includes: a through-hole into which a spindle having small-diameter and large-diameter shaft portions arranged side-by-side in a direction of an axis and having different outer diameters is fitted; a first fitting outer surface which an inner surface of a cylindrical iron core can be fitted; and second fitting outer surfaces disposed on both outer sides of and adjacent to the first fitting outer surface in the direction of the axis and which inner surfaces of a pair of cylindrical side rings can be fitted. The through-hole includes a small-diameter hole portion to which the small-diameter shaft portion is fitted, a large-diameter hole portion to which the large-diameter shaft portion is fitted, and an intermediate hole portion disposed between the small-diameter hole portion and large-diameter hole portion in the direction of the axis, a hydraulic oil pressure supplied between the fitted spindle and the intermediate hole portion.

### TECHNICAL FIELD

The present disclosure relates to a rotor sleeve, a rotor, and a motor.

### BACKGROUND

A known rotor includes a sleeve fitted to an outer circumferential surface of a spindle while forming an enclosed gap therebetween, and a cylindrical iron core fitted to the outer circumferential surface of the sleeve (for example, see Japanese Translation of PCT International Application, Publication No. 2008-515365). Clamp disks are also fitted to the outer circumferential surface of the sleeve, on both outer sides of the iron core in the direction of an axis.

When disassembling this rotor, a hydraulic oil pressure is supplied to the gap between the spindle and the sleeve to expand the sleeve in the radial direction with the iron core and the clamp disks fitted thereto. By continuing to supply the hydraulic oil pressure until the contact pressure at the fitting portion between the spindle and the sleeve reaches zero, the sleeve is removed from the spindle.

### SUMMARY

An aspect of the present disclosure is a rotor sleeve including: a through-hole into which a spindle having a small-diameter shaft portion and a large-diameter shaft portion arranged side-by-side in a direction of an axis and having different outer diameters is fitted; a first fitting outer surface to which an inner surface of a cylindrical iron core can be fitted; and second fitting outer surfaces disposed on both outer sides of and adjacent to the first fitting outer surface in the direction of the axis and to which inner surfaces of a pair of cylindrical side rings can be fitted. The through-hole includes a small-diameter hole portion to which the small-diameter shaft portion is fitted, a large-diameter hole portion to which the large-diameter shaft portion is fitted, and an intermediate hole portion disposed between the small-diameter hole portion and the large-diameter hole portion in the direction of the axis, a hydraulic oil pressure being supplied to a space between the fitted spindle and the intermediate hole portion. An inner diameter of the through-hole at a portion located radially inward of a second fitting outer surface on the small-diameter hole portion side is larger than an inner diameter of the small-diameter hole portion located radially inward of the first fitting outer surface, and an inner diameter of the through-hole at a portion located radially inward of a second fitting outer surface on the large-diameter hole portion side is larger than an inner diameter of the large-diameter hole portion located radially inward of the first fitting outer surface.

### BRIEF DESCRIPTION OF DRAWINGS

FIG. 1 is a vertical sectional view of a rotor according to a first embodiment of the present disclosure.

FIG. 2 is a side view showing a part of a spindle constituting the rotor in FIG. 1.

FIG. 3 is a vertical sectional view showing a sleeve according to the first embodiment of the present disclosure.

FIG. 4 is a vertical sectional view showing a state in which an iron core and side rings are fitted to the sleeve in FIG. 3.

FIG. 5 is a vertical sectional view showing a part of a first modification of the rotor in FIG. 1.

FIG. 6 is a vertical sectional view showing a second modification of the rotor in FIG. 1.

### DETAILED DESCRIPTION OF EMBODIMENTS

Hereinbelow, a sleeve 10 and a rotor 1 according to an embodiment of the present disclosure will be described with reference to the drawings. In addition, in all the drawings referred to in the following description, components are illustrated in an exaggerated manner for ease of understanding.

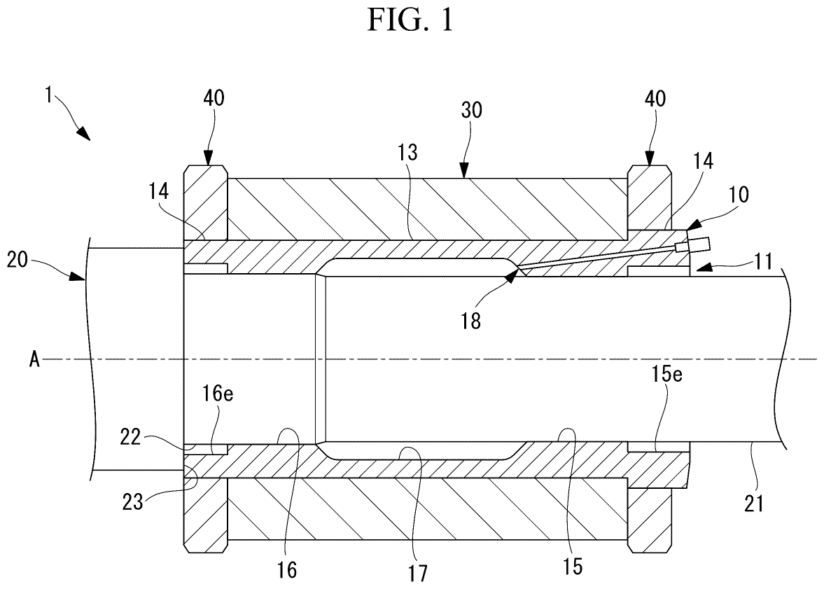

The rotor 1 according to this embodiment is, for example, a rotor for a built-in motor in which a stator is incorporated in an industrial machine. As shown in FIG. 1, the rotor 1 includes a spindle 20 and a cylindrical sleeve (rotor sleeve) 10 having a through-hole 11 into which the spindle 20 is fitted. The rotor 1 includes an iron core 30 and two side rings 40 fixed to the outer circumferential surface of the sleeve 10.

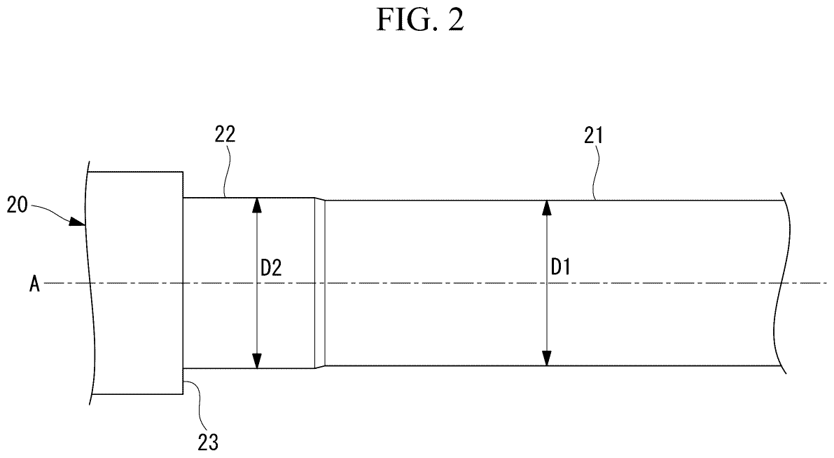

As shown in FIGS. 1 and 2, the spindle 20 includes a small-diameter shaft portion 21 and a large-diameter shaft portion 22 that are arranged side-by-side in a direction along the axis A. The spindle 20 has a locating surface 23 to be abutted against one end of the sleeve 10 in the direction along the axis A.

The small-diameter shaft portion 21 and the large-diameter shaft portion 22 each have a smooth cylindrical outer surface, and the outer diameter D1 of the small-diameter shaft portion 21 is smaller than the outer diameter D2 of the large-diameter shaft portion 22. Furthermore, between the small-diameter shaft portion 21 and the large-diameter shaft portion 22, a step having a height corresponding to the difference between the outer diameters ((D2−D1)/2) is formed.

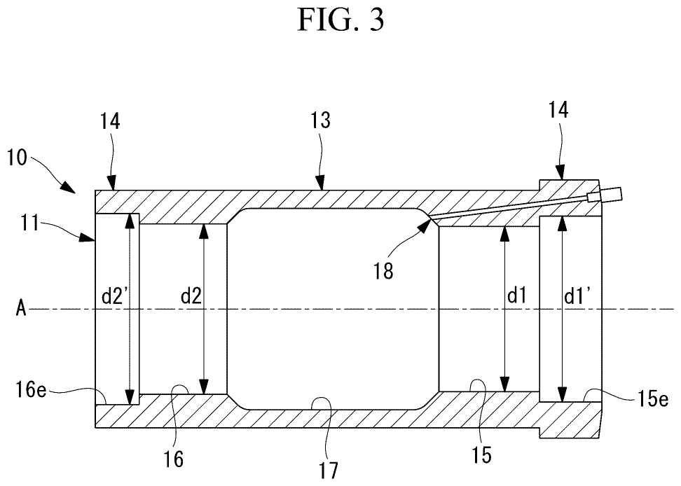

As shown in FIGS. 1 and 3, the sleeve 10 has an outer circumferential surface (first fitting outer surface) 13 to which the iron core 30 described below is fitted at the central position in the direction of the axis A. The sleeve 10 also has a pair of outer circumferential surfaces (second fitting outer surfaces) 14 on both outer sides of and adjacent to the outer circumferential surface 13 in the direction of the axis A, to which side rings 40 described below are fitted.

The iron core 30 is formed in a cylindrical shape by laminating, in a plate thickness direction, a plurality of members obtained by punching a thin plate made of a magnetic material, such as an electrical steel plate, into an annular shape. The inner circumferential surface of the iron core 30 is fitted to the outer circumferential surface 13 of the sleeve 10 and is in close contact therewith over the entire circumference.

Each of the side rings 40 is an annular member having an outer diameter larger than that of the iron core 30, and is fitted to the corresponding outer circumferential surface 14, similarly to the iron core 30. Specifically, the pair of side rings 40 are disposed on both outer sides of the iron core 30 in the direction of the axis A to protect the iron core 30 from contacting the inner surface of the stator when the rotor 1 is inserted into the stator. The side rings 40 have a plurality of screw holes (not shown) for fixing weights for adjusting the balance of the rotor 1.

In this embodiment, the side rings 40 are made of a nonmagnetic material to reduce leakage magnetic flux in the direction of the axis A of the magnetic flux passing through the iron core 30. Typically, the coefficient of linear expansion of a nonmagnetic material is larger than that of the magnetic material constituting the iron core 30. Thus, the side rings 40 are fitted to the sleeve 10 with larger interferences than that of the iron core 30.

More specifically, when the iron core 30 and the side rings 40 are fitted to the outer circumferential surfaces 13 and 14 of the sleeve 10, the iron core 30 and the side rings 40 are fitted to the sleeve 10 in a state in which the iron core 30 and the side rings 40 are heated so that the inner diameters thereof are increased. Then, as the iron core 30 and the side rings 40 are cooled to room temperature, the inner diameters thereof contract, and thus, the iron core 30 and the side rings 40 are fixed in a close contact state, that is, shrink-fitted, to the outer circumferential surfaces 13 and 14 of the sleeve 10.

The shrink fitting is also performed when the spindle 20 is fitted into the through-hole 11 in the sleeve 10, to which the iron core 30 and the side rings 40 have been shrink-fitted, as described above. In this case, if the interference of the iron core 30 with respect to the sleeve 10 and the interferences of the side rings 40 with respect to the sleeve 10 are equal, the side rings 40, which have a large coefficient of linear expansion, may be loosened and fall off due to heating during the shrink fitting. Hence, the interferences of the side rings 40 are set to be larger than the interference of the iron core 30 to prevent the side rings 40 from falling off during the shrink fitting.

As shown in FIG. 1, the through-hole 11 in the sleeve 10 has, at one end thereof in the direction of the axis A, a small-diameter hole portion 15 to which the small-diameter shaft portion 21 of the spindle 20 is fitted and, at the other end, a large-diameter hole portion 16 to which the large-diameter shaft portion 22 of the spindle 20 is fitted. The through-hole 11 also has an intermediate hole portion 17, which is disposed between the small-diameter hole portion 15 and the large-diameter hole portion 16 in the direction of the axis A and has a larger inner diameter than the large-diameter hole portion 16.

The through-hole 11 further has an end hole portion 15e located radially inward of one outer circumferential surface 14, on the outer side of the small-diameter hole portion 15 in the direction of the axis A. Similarly, the through-hole 11 has an end hole portion 16e located radially inward of the other outer circumferential surface 14, on the outer side of the large-diameter hole portion 16 in the direction of the axis A.

As shown in FIG. 3, the dimensions of the sleeve 10 in a normal temperature state before the iron core 30 and the side rings 40 are fitted to each other are set as follows.

Specifically, the inner diameters d1 and d2 of the small-diameter hole portion 15 and the large-diameter hole portion 16 are set to be smaller than the outer diameters D1 and D2 of the small-diameter shaft portion 21 and the large-diameter shaft portion 22 of the spindle 20, respectively, by the amount of the interferences.

Meanwhile, the inner diameter d′ of the end hole portion 15e is set to be larger than the outer diameter D1 of the small-diameter shaft portion 21 of the spindle 20, and the inner diameter d2′ of the end hole portion 16e is set to be larger than the outer diameter D2 of the large-diameter shaft portion 22 of the spindle 20. For example, the inner diameters d1′ and d2′ are respectively set such that the dimensional differences (d1′−D1) and (d2′−D2) are larger than or equal to the amounts of contraction of the inner diameters d1′ and d2′ occurring in the shrink fitting of the side rings 40 described below.

The intermediate hole portion 17 defines an enclosed cylindrical space between the intermediate hole portion 17 and the outer circumferential surface of the spindle 20 when the spindle 20 is fitted to the through-hole 11. A hydraulic oil pressure supply hole 18 through which a hydraulic oil pressure is supplied from the outside of the sleeve 10 is provided in the space defined by the intermediate hole portion 17.

The operation of the thus-configured sleeve 10 and rotor 1 according to this embodiment will be described below.

In assembling the rotor 1 according to this embodiment, first, the iron core 30 and the side rings 40 are fitted, by shrink fitting, to the outer circumferential surface 13 and the pair of outer circumferential surfaces 14 of the sleeve 10, respectively. Thus, a unit in which the iron core 30 and the side rings 40 are integrally attached to the sleeve 10 is formed.

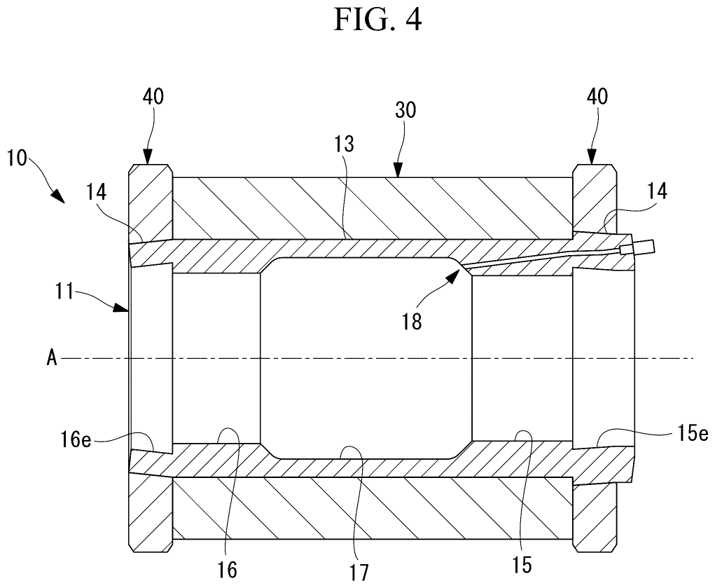

As described above, by being cooled to room temperature after the iron core 30 and the side rings 40 are shrink-fitted, the sleeve 10 is subjected to stresses corresponding to the sizes of the interferences of these members. That is, in the sleeve 10, portions corresponding to the side rings 40, which are fitted with larger interferences, are subjected to a larger stress than a portion corresponding to the iron core 30. Hence, as shown in FIG. 4, the end hole portions 15e and 16e of the through-hole 11 in the sleeve 10 are slightly deformed radially inward, that is, the inner diameters d1′ and d2 ′ are contracted.

Next, in order to attach the unit in this state to the spindle 20, the unit is heated, and the spindle 20 is inserted, by shrink fitting, into the through-hole 11 in the sleeve 10 from the large-diameter hole portion 16 side toward the small-diameter hole portion 15 side. The spindle 20 and the sleeve 10 are positioned in the direction of the axis A by abutting the locating surface 23 of the spindle 20 against the end surface of the end hole portion 16e of the sleeve 10.

Thereafter, by cooling the unit to room temperature, the small-diameter shaft portion 21 and the large-diameter shaft portion 22 of the spindle 20 are fitted in a close contact state to the small-diameter hole portion 15 and the large-diameter hole portion 16 of the sleeve 10, respectively, and thus, the rotor 1 is assembled.

In this case, the inner diameters of the end hole portions 15e and 16e of the sleeve 10 before the iron core 30 and the side rings 40 are fitted are set to be larger than the inner diameters of the small-diameter hole portion 15 and the large-diameter hole portion 16 adjacent thereto, respectively. Hence, even if the inner diameters of the end hole portions 15e and 16e are contracted by fitting the side rings 40, it is possible to ensure that the inner diameter of the end hole portion 15e is larger than or equal to the inner diameter of the small-diameter hole portion 15, and that the inner diameter of the end hole portion 16e is larger than or equal to the inner diameter of the large-diameter hole portion 16.

Specifically, when the above-described unit is shrink-fitted to the spindle 20, fitting of the small-diameter shaft portion 21 to the small-diameter hole portion 15 and fitting of the large-diameter shaft portion 22 to the large-diameter hole portion 16 are not hindered by contracted end hole portions 15e and 16e.

Meanwhile, when the rotor 1 is disassembled, a hydraulic oil pressure is supplied to the space between the intermediate hole portion 17 and the outer circumferential surface of the spindle 20 to expand the through-hole 11 in the radial direction. Then, the spindle 20 and the sleeve 10 are separated from each other by continuing to supply the hydraulic oil pressure until the fitting between the small-diameter hole portion 15 and the small-diameter shaft portion 21 and the fitting between the large-diameter hole portion 16 and the large-diameter shaft portion 22 are released.

Also in this case, because the outer circumferential surface of the spindle 20 is not tightened by the contracted end hole portions 15e and 16e, the extraction of the spindle 20 from the through-hole 11 in the sleeve 10 is not hindered by the contracted end hole portions 15e and 16e.

Hence, when the rotor 1 is disassembled, there is no need to supply a hydraulic oil pressure higher than necessary. Thus, the working efficiency when the sleeve 10 is removed from the spindle 20 improves.

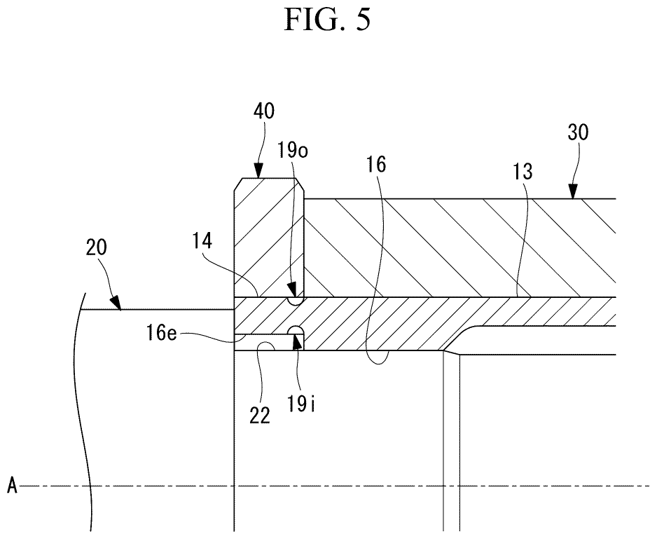

In this embodiment, as shown in FIG. 5, the sleeve 10 may have fragile portions, in which the cross-sectional area thereof is locally reduced, at boundaries between the portion thereof corresponding to the iron core 30 and the portions thereof corresponding to the side rings 40.

In the example in FIG. 5, the fragile portions are formed of circumferential grooves 190 and 191 each provided at the boundaries between the outer circumferential surface 13 and the pair of outer circumferential surfaces 14, the boundary between the small-diameter hole portion 15 and the end hole portion 15e, and the boundary between the large-diameter hole portion 16 and the end hole portion 16e.

This reduces the flexural rigidity of the sleeve 10 at the boundaries between the end hole portion 15e and the small-diameter hole portion 15 and between the end hole portion 16e and the large-diameter hole portion 16. Hence, when the side rings 40 are fitted to the outer circumferential surfaces 14, the end hole portions 15e and 16e are easily deformed radially inward. Specifically, even when large stresses act on the end hole portions 15e and 16e due to fitting of the side rings 40, it is possible to inhibit the stresses from being transmitted to the small-diameter hole portion 15 and the large-diameter hole portion 16.

Hence, deformation of the small-diameter hole portion 15 and the large-diameter hole portion 16 due to fitting of the side rings 40 is suppressed, and it is possible to prevent the small-diameter hole portion 15 and the large-diameter hole portion 16 from being fitted to the spindle 20 more firmly than necessary.

Furthermore, in this case, one of the circumferential grooves 190 and 19i may be omitted, or the circumferential grooves 190 and 19i may be formed of a plurality of grooves arranged intermittently in the circumferential direction. Alternatively, the fragile portion may be formed in a shape other than a groove, as long as the fragile portion locally reduces the cross-sectional area of the sleeve 10 at the boundaries between the portion corresponding to the iron core 30 and the portions corresponding to the side rings 40.

In this embodiment, the side rings 40 are made of a nonmagnetic material, but the present invention is not limited thereto. For example, the side rings 40 may be made of a magnetic material, similarly to the iron core 30.

In this case, because the coefficients of linear expansion of the iron core 30 and the side rings 40 are equal, the interferences of the iron core 30 and the side rings 40 with respect to the sleeve 10 can be set to be equal. Specifically, it is possible to prevent the end hole portions 15e and 16e from being deformed radially inward due to a difference in interference between the iron core 30 and the side rings 40.

Even if the interferences of the iron core 30 and the side rings 40 are equal, when the machine accuracies, etc., of the iron core 30 and the side rings 40 are different, the end hole portions 15e and 16e may be deformed radially inward. For example, if the circularity of the inner circumferential surfaces of the side rings 40 is worse than the circularity of the inner circumferential surface of the iron core 30, the end hole portions 15e and 16e of the through-hole 11 are deformed radially inward even more.

Also in this case, the same effect as described above can be obtained by applying the sleeve 10 or the rotor 1 according to this embodiment.

In this embodiment, the small-diameter hole portion 15 and the large-diameter hole portion 16 of the sleeve 10 are fixed in close contact manner to the small-diameter shaft portion 21 and the large-diameter shaft portion 22, respectively, over the entire circumferences thereof. Alternatively, the small-diameter hole portion 15 and the large-diameter hole portion 16 may be partially fixed to the small-diameter shaft portion 21 and the large-diameter shaft portion 22, respectively.

For example, a plurality of linear grooves extending in the direction of the axis A may be arranged at equal intervals in the circumferential direction, in the inner circumferential surfaces of the small-diameter hole portion 15 and the large-diameter hole portion 16.

In this case, it is possible to optimize the fitting area between the small-diameter hole portion 15 and the small-diameter shaft portion 21 and the fitting area between the large-diameter hole portion 16 and the large-diameter shaft portion 22 by adjusting the width of the linear grooves and the like. This makes it possible to more easily remove the sleeve 10 from the spindle 20.

In this case, however, the inner circumferential surfaces of the end hole portions 15e and 16e need to be in close contact with the outer circumferential surfaces of the small-diameter shaft portion 21 and the large-diameter shaft portion 22, respectively, to prevent the hydraulic oil pressure supplied when the sleeve 10 is removed from leaking through the linear grooves. In this case, the same effect as described above can be obtained by making the interferences of the end hole portions 15e and 16e with respect to the spindle 20 smaller than the interferences of the small-diameter hole portion 15 and the large-diameter hole portion 16.

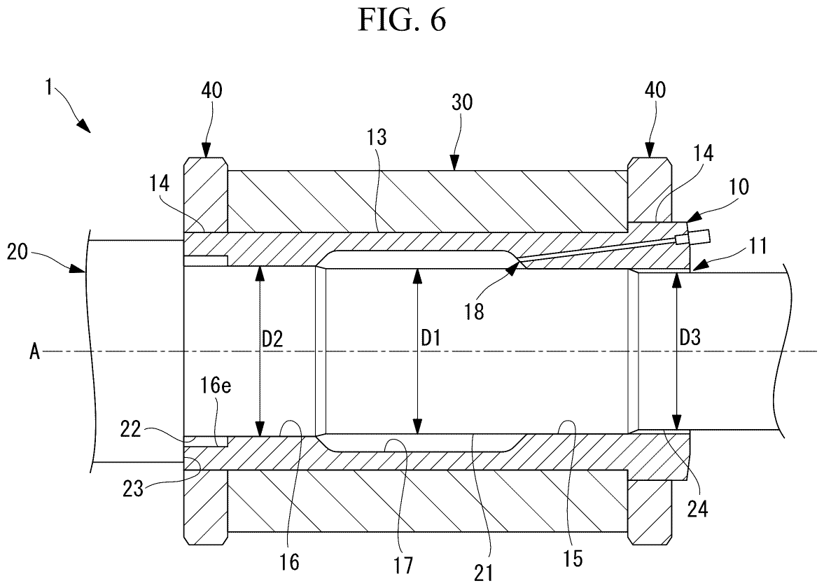

In this embodiment, as shown in FIG. 6, a step portion 24 adjacent to the outer side of the small-diameter shaft portion 21 of the spindle 20 in the direction of the axis A may be provided instead of the end hole portion 15e on the small-diameter hole portion 15 side.

In the example in FIG. 6, the step portion 24 has an outer diameter D3 smaller than the outer diameter D1 of the small-diameter shaft portion 21. Hence, between the small-diameter shaft portion 21 and the step portion 24, a step having a height corresponding to the difference between the outer diameters ((D1−D3)/2) is formed. In a state in which the rotor 1 is assembled, the step portion 24 is disposed radially inward of the portion of the small-diameter hole portion 15 corresponding to the side ring 40.

Thus, an allowance having a size corresponding to the step between the small-diameter shaft portion 21 and the step portion 24 ((D1−D3)/2) is formed between the inner circumferential surface of the portion of the small-diameter hole portion 15 corresponding to the side ring 40 and the outer circumferential surface of the step portion 24.

Thus, even if the portion of the small-diameter hole portion 15 corresponding to the side ring 40 is deformed radially inward due to fitting of the side ring 40, it is possible to absorb the deformation by the allowance created by the step portion 24.

Hence, it is possible to prevent the inner circumferential surface of the small-diameter hole portion 15 from being fitted to the outer circumferential surface of the spindle 20 more firmly than necessary. Meanwhile, on the large-diameter hole portion 16 side of the sleeve 10, as in the above-described embodiment, by providing the sleeve 10 with the end hole portion 16e, the sleeve 10 and the spindle 20 are prevented from being fitted to each other more firmly than necessary. Thus, the same effects as described above can be obtained also in the embodiment shown in FIG. 6.

In this embodiment, the inner diameters d1′ and d2′ of the end hole portions 15e and 16e are set such that the dimensional differences (d1′−D1) and (d2′−D2) are larger than or equal to the amounts of contraction of the inner diameters d1′ and d2′ occurring in the shrink fitting of the side rings 40. Alternatively, the dimensional differences (d1′−D1) and (d2′−D2) may be smaller than the amounts of contraction of the inner diameters d1′ and d2′ occurring in the shrink fitting of the side rings 40. In this case, the sleeve 10 and the spindle 20 are in close contact with each other also at the end hole portions 15e and 16e. However, the fixing force between the sleeve 10 and the spindle 20 is lower than that in the case where the end hole portions 15e and 16e are not provided. Hence, it is possible to improve the ease of assembly and disassembly of the rotor 1.

As described above, the end hole portions in the drawings are illustrated in an exaggerated manner, and in reality, the amounts of contraction of the inner diameters d1′ and d2′ of the end hole portions 15e and 16e occurring in the shrink fitting may be so minute as not to appear in the drawings. Hence, the small-diameter hole portion 15 and the large-diameter hole portion 16 may be fitted by interference fit, and the end hole portions 15e and 16e may be fitted by clearance fit, so that the size relationship is defined within the range of dimensional tolerance, using the same nominal dimensions.

Although the embodiment of the present disclosure has been described in detail above, the present disclosure is not limited to the above-described embodiment. Various additions, replacements, changes, partial deletion, and the like can be made to these embodiments without departing from the gist of the invention or without departing from the idea and the gist of the present invention derived from the contents described in the claims and equivalents thereof. For example, in the above-described embodiment, the order of operations and the order of processes are shown as examples and are not exhaustive.

The following additional features are further disclosed in relation to the above-described embodiment and modifications.

### Note 1

A rotor sleeve including: a through-hole into which a spindle having a small-diameter shaft portion and a large-diameter shaft portion arranged side-by-side in a direction of an axis and having different outer diameters is fitted; a first fitting outer surface to which an inner surface of a cylindrical iron core can be fitted; and second fitting outer surfaces disposed on both outer sides of and adjacent to the first fitting outer surface in the direction of the axis and to which inner surfaces of a pair of cylindrical side rings can be fitted, wherein the through-hole includes a small-diameter hole portion to which the small-diameter shaft portion is fitted, a large-diameter hole portion to which the large-diameter shaft portion is fitted, and an intermediate hole portion disposed between the small-diameter hole portion and the large-diameter hole portion in the direction of the axis, a hydraulic oil pressure being supplied to a space between the fitted spindle and the intermediate hole portion, an inner diameter of the through-hole at a portion located radially inward of a second fitting outer surface on the small-diameter hole portion side is larger than an inner diameter of the small-diameter hole portion located radially inward of the first fitting outer surface, and an inner diameter of the through-hole at a portion located radially inward of a second fitting outer surface on the large-diameter hole portion side is larger than an inner diameter of the large-diameter hole portion located radially inward of the first fitting outer surface.

### Note 2

The rotor sleeve according to Note 1, wherein at least one of: boundaries between the first fitting outer surface and the second fitting outer surfaces; or portions of an inner surface of the through-hole corresponding to the boundaries is provided with a fragile portion that locally reduces a cross-sectional area of the rotor sleeve.

### Note 3

The rotor sleeve according to Note 2, wherein the fragile portion is a groove extending in a circumferential direction in at least one of the boundaries or the portions of the inner surface of the through-hole corresponding to the boundaries.

### Note 4

A rotor including: the rotor sleeve according to any one of Notes 1 to 3; the iron core shrink-fitted to the first fitting outer surface; and the pair of side rings shrink-fitted to the second fitting outer surfaces.

### Note 5

The rotor according to Note 4, wherein the side rings are formed of a nonmagnetic material.

### Note 6

The rotor according to Note 4 or 5, further including the spindle fitted in the through-hole.

### Note 7

A motor including the rotor according to any one of Notes 4 to 6.

1. A rotor sleeve comprising:
a through-hole into which a spindle having a small-diameter shaft portion and a large-diameter shaft portion arranged side-by-side in a direction of an axis and having different outer diameters is fitted;
a first fitting outer surface to which an inner surface of a cylindrical iron core can be fitted; and
second fitting outer surfaces disposed on both outer sides of and adjacent to the first fitting outer surface in the direction of the axis and to which inner surfaces of a pair of cylindrical side rings can be fitted, wherein
the through-hole includes a small-diameter hole portion to which the small-diameter shaft portion is fitted, a large-diameter hole portion to which the large-diameter shaft portion is fitted, and an intermediate hole portion disposed between the small-diameter hole portion and the large-diameter hole portion in the direction of the axis, a hydraulic oil pressure being supplied to a space between the fitted spindle and the intermediate hole portion,
an inner diameter of the through-hole at a portion located radially inward of a second fitting outer surface on the small-diameter hole portion side is larger than an inner diameter of the small-diameter hole portion located radially inward of the first fitting outer surface, and an inner diameter of the through-hole at a portion located radially inward of a second fitting outer surface on the large-diameter hole portion side is larger than an inner diameter of the large-diameter hole portion located radially inward of the first fitting outer surface.

2. The rotor sleeve according to claim 1, further comprising a fragile portion that locally reduces a cross-sectional area of the rotor sleeve that is provided to at least one of: boundaries between the first fitting outer surface and the second fitting outer surfaces; or portions of an inner surface of the through-hole corresponding to the boundaries.

3. The rotor sleeve according to claim 2, wherein the fragile portion is a groove extending in a circumferential direction in at least one of the boundaries or the portions of the inner surface of the through-hole corresponding to the boundaries.

4. A rotor comprising:
the rotor sleeve according to claim 1;
the iron core shrink-fitted to the first fitting outer surface; and
the pair of side rings shrink-fitted to the second fitting outer surfaces.

5. The rotor according to claim 4, wherein the side rings are formed of a nonmagnetic material.

6. The rotor according to claim 4, further comprising the spindle fitted in the through-hole.

7. A motor comprising the rotor according to claim 4.
